(19) United States
(12) Patent Application Publication
(10) Pub. No.: US 2008/0057468 A1
(43) Pub. Date: Mar. 6, 2008

(54) Endodontic Instrument

(75) Inventors: Kenneth Rosenblood, Los Angeles, CA (US); Nancy N. Quan, North Hills, CA (US)

Correspondence Address: DISCUS DENTAL IMPRESSIONS, INC., 8550 HIGUERA STREET, CULVER CITY, CA, 90232, US

(73) Assignee: Discus Dental, LLC, Culver City, CA (US)

(21) Appl. No.: 11/927,965

(22) Filed: Oct. 30, 2007

Related U.S. Application Data
(63) Continuation of application No. 11/305,173, filed on Dec. 15, 2005.
(60) Provisional application No. 60/636,688, filed on Dec. 15, 2004.

(51) Int. Cl. A61C 5/02

(52) U.S. Cl. 433/102

(57) ABSTRACT

The present invention provides an improved endodontic instrument. The instrument can be constructed of a ribbon of material such as any material that has a suitable edge for cutting and can be twisted or bent into any desired shape. The ribbon can be made of a metal, a polymeric film or combinations thereof. The ribbon can have a straight edge or a serrated one. The instrument is in the shape of a cone, tapering towards one end. It has a hollow interior and cutting edges disposed in a helical pattern along its length. The instrument can perform various or all of the functions of any endodontic instrument used in the root canal procedure.

### CROSS-REFERENCE TO RELATED APPLICATION

The present invention claims the benefit of U.S. Provisional Patent Application No. 60/636,688 filed Dec. 15, 2004 and titled “Endodontic Instruments,” the disclosure of the foregoing being herewith incorporated by reference in its entirety.

### FIELD OF THE INVENTION

This invention relates to dental instruments in general. Specifically, this invention relates to endodontic instruments for use in root canal dental procedures.

### BACKGROUND OF THE INVENTION

Both circulatory and neural support for a tooth enters the tooth at the terminus of each root. During a root canal operation, any diseased pulp tissue in the root canal is extracted using tapered endodontic files and reamers. Since the root canals are small, curved and calcified, the instruments used have to withstand high torsional stresses during such removal process so as not to complicate the treatment by breaking.

The endodontic files and reamers used to clean out and shape the root canal are rotated and reciprocated in the canal by dentists, either manually or with the aid of dental handpieces onto which the files are mounted. Files of increasingly larger diameters are generally used in sequence in order to achieve the desired cleaning and shaping.

Many endodontic instruments used for this operation have torsional limitations. Some of the improved ones are disclosed in U.S. Pat. Nos. 4,538,989, 5,464,362, 5,527,205, 5,628,674, 5,655,950, 5,762,497, 5,762,541, 5,833,457, 5,941,760, and 6,293,795. The contents of these are incorporated herein by reference. These patents teach endodontic files made with an alloy of nickel/titanium containing more than 40% titanium.

The files and reamers also have varying designs of cutting edges and some of these designs are disclosed in U.S. Pat. Nos. 4,299,571, 4,332,561, 4,353,698, 4,457,710, 4,904,185, 5,035,617, 5,067,900, 5,083,923, 5,104,316, 5,275,562, 5,735,689, 5,902,106, 5,938,440, 5,980,250, 6,937,94, and 6,419,488, 6,428,317, and Patent Application Publication Nos. US2002/0137008 A1, and US2004/0023186 A1, incorporated herein by reference.

Once the diseased tissue is removed from the root canal, the canal is sealed with a viscous sealing compound such as gutta-percha. Since the instruments used in the tissue removal are generally not suitable for the delivery, packing and/or filling of the canal with gutta-percha, the sealing action is effected by reciprocating and/or rotating a condenser or compactor instrument in the canal. These instruments, like the reamers and files used in tissue removal, also need to be able to withstand the high torsional stresses of packing and compacting without leaving any voids that may lead to complications later.

### SUMMARY OF THE INVENTION

The present invention comprises novel endodontic instruments used in root canal operations.

These novel endodontic instruments are capable of being used for all stages of the root canal operations, including removal of diseased tissues from the root canals, and delivery, filling and/or packing of gutta-percha and/or other similar materials into the vacated root canals.

The endodontic instruments of the present invention can be rotated and reciprocated in the canal by the dentist, either manually or with the aid of a rotating dental handpiece, to which the instruments can be mounted.

The endodontic instruments of the present invention are substantially cone-shaped, like a tornado or an inverse tornado, comprising substantially hollow interiors, as opposed to the solid interiors of instruments in the prior art, said substantially hollow interiors can facilitate the removal of diseased tissue and/or tooth chips from the canal

Further, an instrument of the present invention comprises turns of a ribbon material, winding telescopingly along the longitudinal axis of the cone, from the largest diameter at the base of the cone to the smallest diameter at the tip of the cone, in such a manner that at least a portion of one turn in the winding overlaps at least a portion of another turn immediately adjacent to it in the winding, i.e., either the preceding and/or the lagging turn. The ribbon is preferably of a relatively thin gauge material comprising metal or polymer.

In one aspect of the invention, the turns along the instruments are wound in such a manner that the turn at issue overlaps at least a portion of the turn from the immediately preceding turn, starting from the base, with the inside of at least a portion of one turn contacting the outside of at least a portion of the turn that immediately follows, or precedes it. The exposed portions or edges of the turns can perform a cutting function.

In another aspect, the substantially hollow interiors of the instruments can aid in the delivering, filling and/or compacting of a sealing material.

Furthermore, an instrument of the present invention can include a continuous ribbon twisted around a post, rod or wire that is tapered towards one end such that the instrument is in the shape of a cone. The smaller diameter end of the post, rod or wire is attached to the ribbon at the tip of the cone while the large diameter end is adapted to be rotated by the dentist, either manually or with the aid of a rotating handpiece to which the instrument can be mounted.

Still furthermore, when an instrument of the present invention is compressed or extended along a longitudinal direction, the diameters of the turns along the length of the cone are changed, with a corresponding change in the length of the cone. This change can either result in changes in the number of turns in the instruments, or changes in the areas of the portions of overlap between adjacent turns while the number of turns remains relatively constant. Therefore, an instrument of the present invention is capable of performing tasks generally being performed by a series of instruments having progressively increasing diameters, which used in sequence, can achieve the desired cleaning and shaping of the root canal.

In a further aspect of the invention, when a twisting or rotating action is applied to the instruments of the present invention, the number of turns or the areas of the portions of overlap between adjacent turns in the instrument can be either increased or decreased, depending on whether the twisting or rotating action is compressive or extensive. This twisting or rotating action can also aid in delivering and/or filling and/or packing the canal with a filling material such as gutta-percha.

The present invention also comprises endodontic instruments that are flexible and resistant to torsional breakage, while conforming to any shape or form needed for root canal operations.

These and other aspects of the invention will be discussed in more detail below.

### BRIEF DESCRIPTION OF THE FIGURES

FIG. 1 illustrates an embodiment of the dental instrument of the present invention;

FIG. 2 illustrates a ribbon having a uniform thickness useful for constructing the instruments of the present invention;

FIG. 3a illustrates an embodiment of the invention in which successive turns of ribbon overlap preceding turns;

FIG. 3b illustrates an embodiment of the invention in which successive turns of ribbon overlap preceding turns and which includes a central rod;

FIG. 4a illustrates an embodiment of the invention in which preceding turns of ribbon overlap successive turns;

FIG. 4b illustrates an embodiment of the invention with a central post in which preceding turns of ribbon overlap successive turns;

FIG. 5 illustrates a dental instrument according to a further embodiment of the invention;

FIGS. 6a-6i illustrate various ribbon configurations according to exemplary embodiments of the invention;

FIG. 7a illustrates a dental instrument according to a further embodiment of the invention;

FIG. 7b illustrates a dental instrument according to a further embodiment of the invention including a central rod;

FIG. 8 illustrates yet another embodiment of the instrument of the present invention comprising a post, rod, or wire;

FIG. 9 illustrates a dental instrument according to one embodiment of the invention including an apparatus for moving one end of a ribbon with respect to another end of the ribbon;

FIG. 10 illustrates an embodiment of the invention including a compactor surface;

FIG. 11 illustrates an embodiment of the invention including a distal aperture;

FIG. 12 illustrates an embodiment of the instrument of the present invention comprising an attachment mode that can be attached to a rotary dental handpiece;

FIG. 13 illustrates another embodiment of the instrument of the present invention comprising an attachment mode that can again be attached to a rotary dental handpiece;

FIG. 14 illustrates a dental instrument according to a further embodiment of the invention; and

FIG. 15 illustrates a dental instrument according to yet another embodiment of the invention.

### DETAILED DESCRIPTION OF THE INVENTION

The detailed description set forth below is intended as a description of the presently preferred device provided in accordance with aspects of the present invention and is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

All publications mentioned herein are incorporated herein by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As is widely known, a root canal therapy is a routine procedure to rid the canal of diseased tissues whereby the canal is cleaned. The dentist then fills and packs the vacated canal with a filling material, which typically comprises a waxy, rubbery compound known as gutta-percha. Then, the tooth above the gutta-percha is topped with a protective cement, and lastly, a crown may be fitted to the tooth.

The instruments of the present invention as used herein include endodontic files, reamers, condensers and compactors.

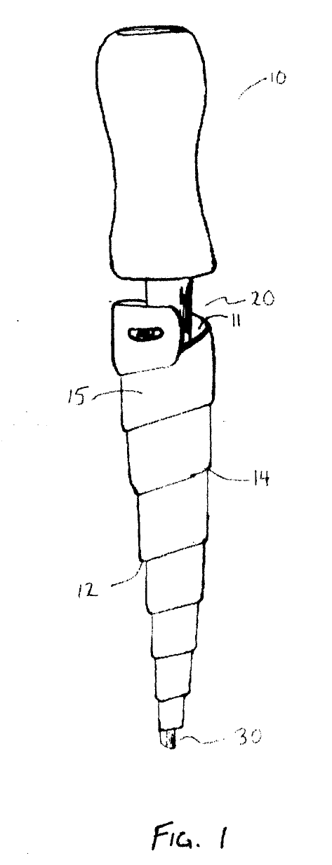

An exemplary instrument 10 is depicted in FIG. 1. It is tapered towards one end, and shaped like a cone, comprising a substantially hollow interior 11, a base 20, a tip 30 and cutting edges 12 in a helical pattern along its length.

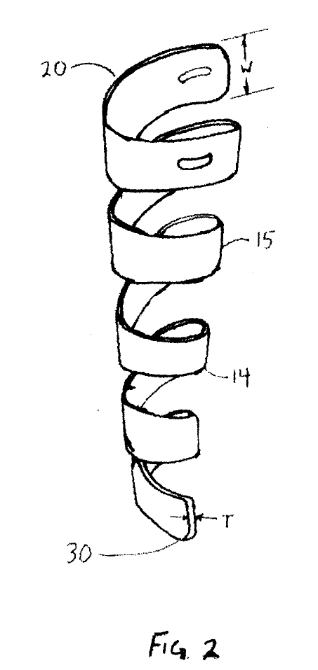

The instrument 10 comprises a continuous length of a ribbon material 15, as further shown in FIG. 2, which ribbon material is preferably of a relatively thin gauge material, comprising a metal, a polymer or combinations thereof, and preferably having a width “W” so that it can be wound into an instrument, such as shown in FIG. 1. The instrument is like a tornado or a twister, with the turns winding telescopically along the longitudinal axis of the cone from the largest diameter at the base 20 of the cone to the smallest diameter at the tip 30. At least a portion of one turn in the winding also preferably overlaps at least a portion of the immediately adjacent turns.

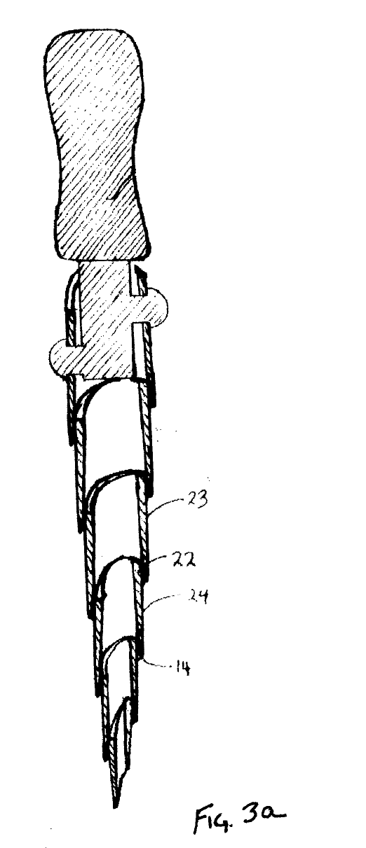

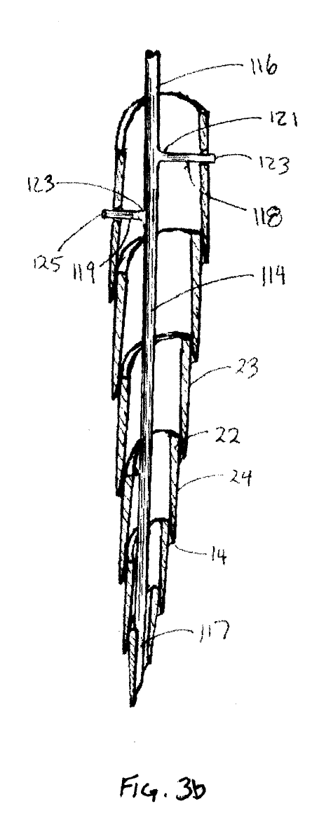

In one embodiment, as shown more clearly in FIG. 3a, the turns are constructed such that a turn of ribbon in issue 23 overlaps 22 at least a portion of a turn of ribbon 24 from the immediately preceding turn, starting from the tip, such that the inside of one turn contacts the outside of the turn that immediately precedes it in the sequence of turns. The result is a helical coil of ribbon with adjacent turns of the coil overlapping one another. The helical coil defines an elongate internal region that, according to one embodiment of the invention is substantially hollow. According to one embodiment of the invention, the helical coil tapers to a point at a distal end thereof. In further embodiments of the invention, a proximal end of the coil is mechanically coupled to, for example, a handle or a coupling member. The coupling member is adapted to be received into a chuck or collet, or other gripping device, of a power tool, such as a rotary handpiece.

In use, the distal end of the helical coil is, for example, inserted into a cavity in a tooth. The helical coil may be pressed into the tooth, withdrawn from the tooth, rotated clockwise within the tooth and rotated counter-clockwise within the tooth. In this manner, the instrument can be extended or contracted by the application of twisting, rotating, extensional and contracting forces.

In a further embodiment, as shown in FIG. 3b, a central rod or wire 114 is disposed in an elongate axial cavity defined by the helical coil of ribbon. The rod 114 has a proximal end 116 and a distal end 117. According to one embodiment of the invention, the proximal end 116 of the wire is coupled to a handle or a coupling member. The distal end of the wire is coupled to the ribbon of the helical coil at a distal end of the ribbon.

According to one embodiment of the invention, the rod 114 includes a first 118 and a second 119 support member. The support members are coupled at respective inward ends 121, 123 thereof, to the rod 114. Respective outward ends 125, 127 of the support members 118, 119 are disposed outwardly of the helical coil of ribbon. Between the respective inward ends and outward ends thereof, the support members 118, 119 are disposed within holes through the ribbon.

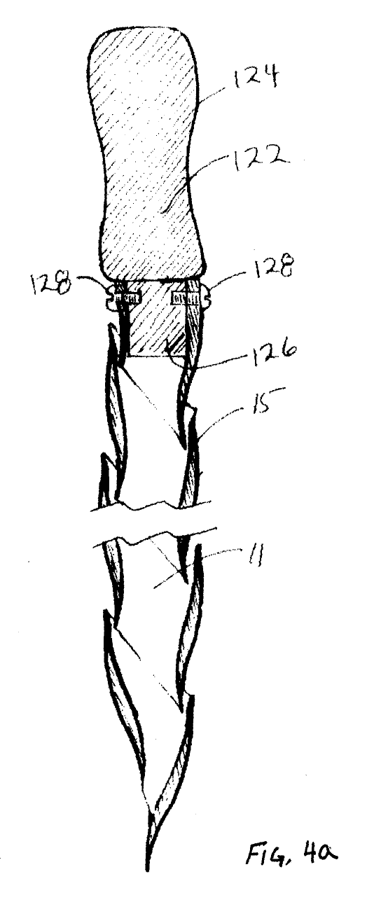

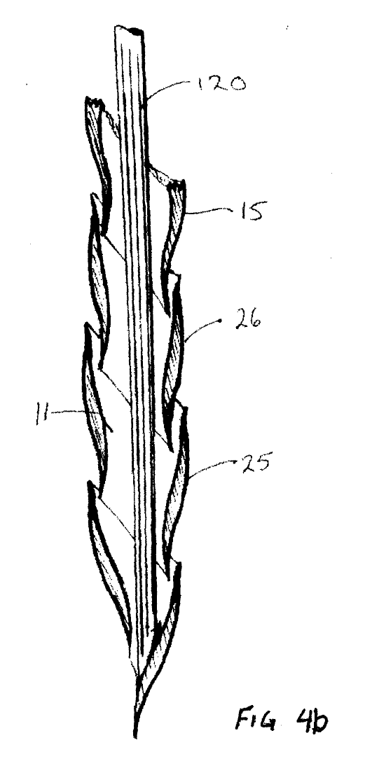

In the embodiment shown in FIG. 4a, the ribbon 15 is formed into an elastic but self-supporting helix. In the illustrated embodiment, the ribbon 15 is coupled to a handle 122 adapted to be manually gripped at an external surface thereof 124 by a user. The handle 122 includes a coupling member 126 at a distal end thereof.

In the illustrated embodiment, the ribbon 15 is coupled to the coupling member 126 by a pair of screws 128 disposed within respective internally threaded bores 130 of the coupling member 126.

In FIG. 4b, the dental instrument of FIG. 4a further includes a central post or shaft 120. The post has a proximal end and a distal end, and the ribbon 15 is wound spirally around the post with the distal end of the post being coupled to one end of the ribbon, i.e., the end forming the tip of the instrument, while the proximal end of the rod is coupled to a handpiece, if a handpiece is used, or is adapted for rotation manually by a dentist, if no handpiece is used. According to one embodiment, the rod is adapted to deform flexibly under torsional and bending stresses and then recover its original shape. In this manner, the rod supports the helical coil of ribbon and adds some structural integrity to the dental instrument while still allowing the diameter and length of the instrument to change, as desired.

The central shaft 120 is coupled at distal and proximal ends thereof to the ribbon 15. The shaft 120 provides torsional and flexural support to the ribbon during use of the dental instrument.

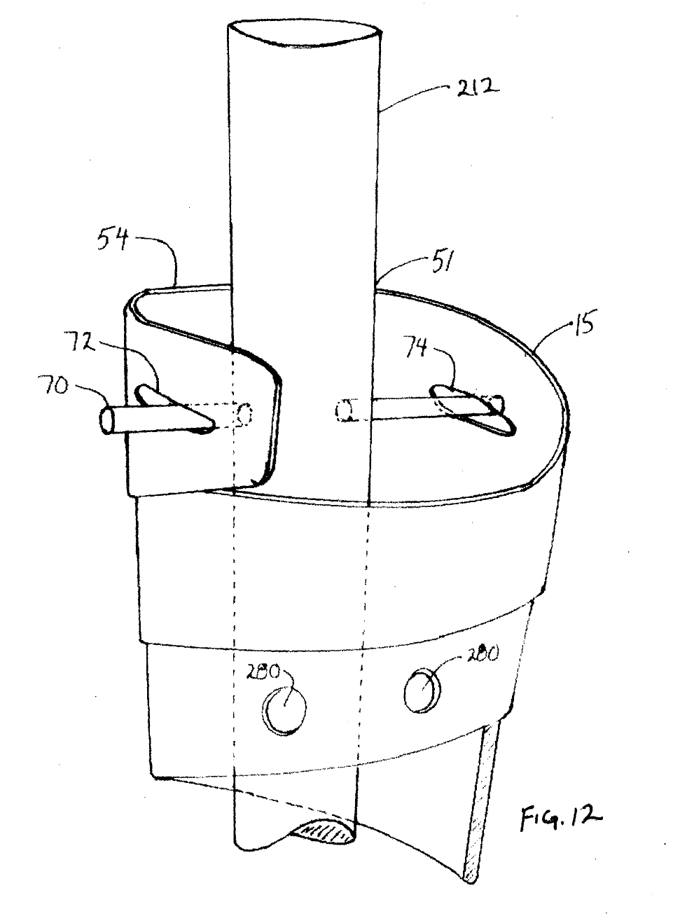

Depending on the materials and particular configuration of components employed, the embodiment of FIG. 4a may be more flexible as compared with the embodiment of FIG. 4b. In addition, the embodiment of FIG. 4a may have comparatively more space in an interior hollow region 11 thereof than a comparably sized instrument of the FIG. 4b embodiment. The availability of a larger hollow region 11 is advantageous inasmuch as it allows the delivery of additional material such as gutta-percha or the extraction of additional debris from a tooth. Further discussion of the advantages of a hollow interior is found, for example, below in relation to FIG. 12.

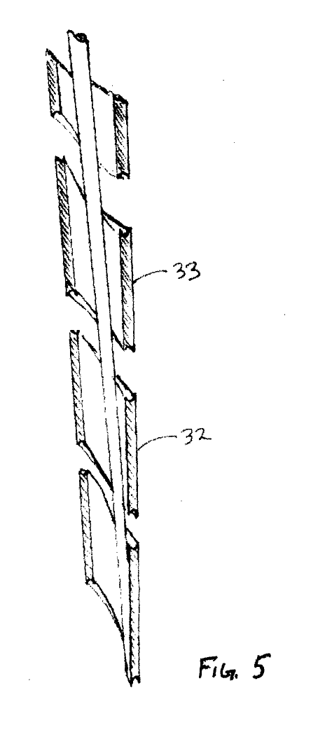

In still another embodiment, a shown in FIG. 5, the turns of ribbon are constructed such that successive turns, e.g. 32, 33 do not overlap, but rather, the turns of ribbon are attached to the post by any attachment means to generate cutting surfaces.

The preferred arrangement of turns are such that the instrument can be extended or contracted by rotating, twisting, extensional action, or contracting action and at the same time presents efficient cutting edges, all else being equal.

In addition to the arrangement of turns, various other factors, such as thickness of the ribbon 15, the uniformity or non-uniformity in the thickness “T” of the ribbon 15, and the tapering or non-tapering of the edge or edges 14 of the ribbon 15 affect the characteristics of a practical dental instrument according to the invention.

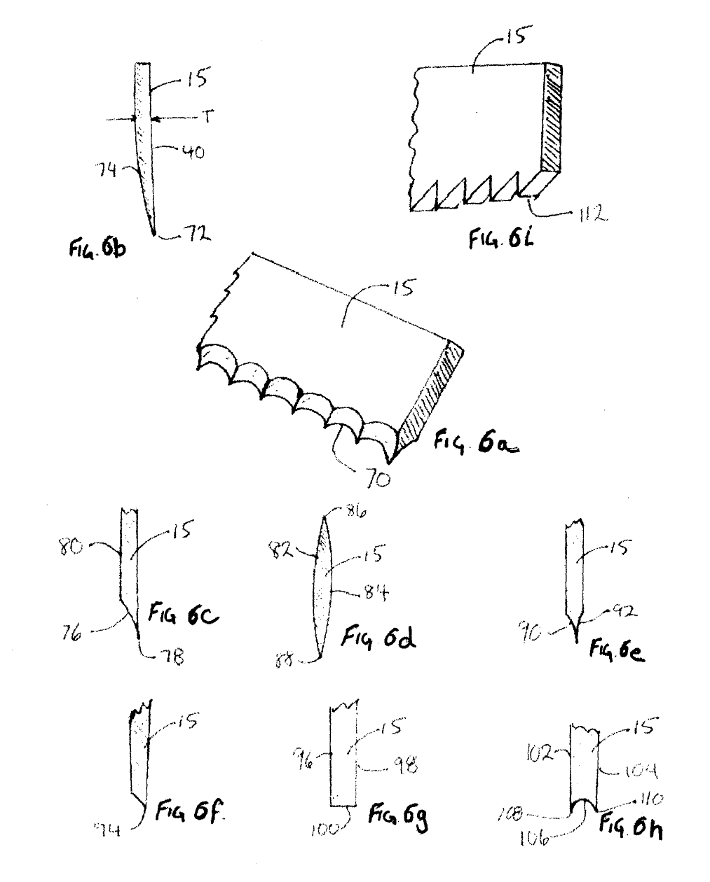

Various exemplary embodiments of ribbon edges are depicted in FIGS. 6a-6i. For example, FIG. 6a shows a ribbon 15 having a serrated edge 70 and FIG. 6b shows a ribbon 15 having a straight edge 72 and a thickness “T” that diminishes monotonically as one traverses the ribbon 15 in the direction of the edge so as to form a convex surface 74.

FIG. 6c shows a ribbon 15 having a concave region 76 adjacent an edge 78 on a single side 80 of the ribbon. According to one embodiment of the invention, the concave region 76 is formed by a hollow-grinding process such that ribbon material is removed from a region adjacent to the surface 80 during manufacturing of the ribbon 15.

FIG. 6d shows a ribbon 15 according to one embodiment of the invention. As shown in FIG. 6d, the ribbon 15 includes first and second convex sides 82, 84. The convex sides 82, 84 meet to define an upper edge 86 and a lower edge 88.

FIG. 6e shows a ribbon 15 according to a further embodiment of the invention. The ribbon 15 of FIG. 6e includes first 90 and second 92 concave regions which, according to one exemplary embodiment of the invention, may be formed by hollow-grinding of the ribbon 15. FIG. 6f shows a ribbon 15 having a chisel point edge 94, and FIG. 6g illustrates a ribbon 15 having first 96 and second 98 sides disposed in substantially parallel spaced relation to one another. A surface 100 is disposed between sides 96 and 98 and in mutually perpendicular relation thereto.

FIG. 6f shows a ribbon 15 according to another embodiment of the invention. In the FIG. 6f embodiment first 102 and second 104 sides are disposed in substantially parallel spaced relation to one another. A further surface 106 is disposed between sides 102 at 104. The further surface 106 is substantially concave, such that it intersects sides 102 at 104 at respective edges 108 and 110.

FIG. 6i shows a ribbon 15 according to another embodiment of the invention in which a lower (or alternately an upper) surface 112 of the ribbon 15 is disposed in a saw-tooth configuration.

One of skill in the art will appreciate that the various edge embodiments shown in FIGS. 6a-6i are merely exemplary of the edges and cutting arrangements that may be beneficially employed according to the present invention. For example, according to a particular embodiment, one or more sides of the ribbon may include a knurled pattern or other pattern adapted to form abrasive or cutting edges thereon. In addition, abrasive particles or other materials may be embedded within the material of ribbon, or adhered to various surfaces thereof whereby the function of the ribbon and of the dental instrument of the invention is further enhanced. Moreover, any or all of these various aspects of the invention disclosed herewith may be used alone or in combination with one another.

In addition to edge configuration, the type of materials used in the construction of the ribbon 15, are all considerations to be taken into account when constructing the preferred instruments of the present invention.

In one embodiment, the ribbon 15 can have a straight edge 14, as shown in FIG. 2 or a serrated edge 70, as shown in FIG. 6a, or combinations thereof. Portions of these edges 14 and 70 form the cutting edges 12 of the instrument 10 (as shown, e.g., in FIG. 1).

In one embodiment, the ribbon 15, useful for the construction of the instrument, has a uniform thickness throughout its length and width, as shown, e.g., in FIG. 6g. If the ribbon 15 is of a sufficiently thin gauge, the instrument can be formed to have sufficiently sharp cutting edges 12, which are of the same thickness as the rest of the ribbon 15. The ribbon 15 can also have a uniform thickness throughout the majority of its area except for a slight tapering toward the edge 14 to improve the sharpness of the edges, shown for example in FIG. 3a.

In yet another embodiment of the invention, if the thickness of the ribbon 15 is uniform across its width and the thickness is not sufficiently thin to produce a good cutting edge 12, the edges 14 of the ribbon 15 can be serrated, such as shown in FIGS. 6i, to improve the cutting efficiency of the instrument.

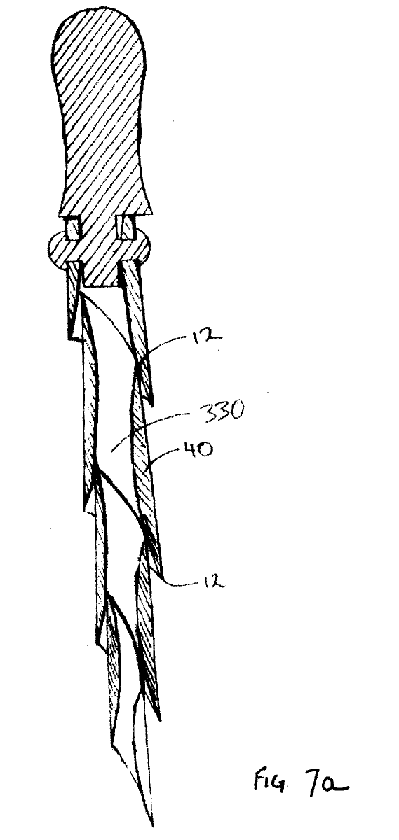

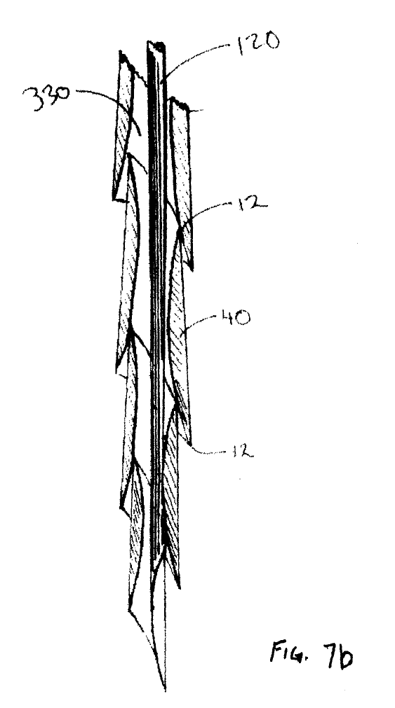

In another embodiment, the ribbon 15 can have a decreasing thickness from the center 40 towards one of the edges 72 as shown in the cross-sectional view depicted in FIG. 6b, or towards both of the edges 12 along its width, as shown for example in FIG. 7a. As illustrated in the FIG. 7a embodiment, the ribbon is disposed in a helical coil defining a substantially hollow axial internal cavity 330.

In a further embodiment of the invention, as shown in FIG. 7b, a rod 120 may be disposed within the substantially hollow internal cavity 330. The rod has an elongate configuration, and has a distal end and a proximal end. The distal end of the rod is mechanically coupled to a distal end of the ribbon, while the proximal end of the rod is mechanically coupled to the proximal end of the ribbon. According to one embodiment, the rod is adapted to deform flexibly under torsional and bending stresses and then recover it's original shape. In this manner, the rod supports the helical coil of ribbon and adds structural integrity to the dental instrument.

The thickness of the ribbon 15 can also affect the durability of the instrument in addition to its cutting efficiency. Thicker ribbons are generally more durable, but can generally also hamper the cutting efficiencies of the instrument. Since not all materials can have the same cutting efficiency, the thicknesses of the ribbons 15 that can form effective cutting edges can also vary with the material it is made of.

In addition, unlike endodontic instruments having shanks made out of solid rods or wires of metal, such as those disclosed in U.S. Pat. Nos. 4,538,989, 5,464,362, 5,527,205, 5,628,674, 5,655,950, 5,762,497, 5,762,541, 5,833,457, 5,941,760, 6,293,795, 4,299,571, 4,332,561, 4,353,698, 4,457,710, 4,904,185, 5,035,617, 5,067,900, 5,083,923, 5,104,316, 5,275,562, 5,735,689, 5,902,106, 5,938,440, 5,980,250, 6,937,94, and 6,419,488, 6,428,317, and Patent Application Publication Nos. US2002/0137008 A1, and US2004/0023186 A1, the contents of which are incorporated herein by reference, which are limited to a few suitable materials due to the torsional limitations discussed above, there is no limitation as to the kind of material suitable for the construction of the instruments of the present invention.

In general, the ribbon 15 can be made of any material that can be formed (as, for example, by casting) into a ribbon form, can form a suitable edge for cutting, and is capable of being twisted or bent into the desired shapes of the present invention without breaking or reaching beyond the yield point of the material. The ribbon 15 can be made of a metal such as stainless steel; an alloy such as Ni/Ti alloy; any amorphous metals including those available from Liquid Metal, Inc. or similar ones, such as those described in U.S. Pat. No. 6,682,611, and U.S. Patent Application No. 2004/0121283, the entire contents of which are incorporated herein by reference; a polymeric film made of polymers such as polyethylene, polypropylene, polybutylene, polystyrene, polyester, acrylic polymers, polyvinylchloride, polyamide, or polyetherimide like ULTEM®; a polymeric alloy such as Xenoy® resin, which is a composite of polycarbonate and polybutyleneterephthalate or Lexan® plastic, which is a copolymer of polycarbonate and isophthalate terephthalate resorcinol resin (all available from GE Plastics), liquid crystal polymers, such as an aromatic polyester or an aromatic polyester amide containing, as a constituent, at least one compound selected from the group consisting of an aromatic hydroxycarboxylic acid, an aromatic hydroxyamine and an aromatic diamine (exemplified in U.S. Pat. Nos. 6,274,242 and 6,797,198, the contents of which are incorporated herein by reference), or combinations thereof.

In addition, a ribbon can be made of any polymeric composite such as engineering prepregs or composites, which are polymers filled with pigments, carbon particles, silica, conductive particles such as metal particles or conductive polymers, or mixtures thereof.

Further, any of the above mentioned ribbons can also have abrading working surfaces coated or embedded with diamond particles or chips onto the ribbon, either throughout the ribbon or towards the edges. The abrading surfaces can also comprise a flexible diamond-like carbon (DLC) coating or titanium nitride coating. For polymeric ribbons, the diamond particles or chips can be directly embedded during casting or forming, or by means of polymeric coating agents. For metallic ribbons, the diamond particles or chips can be coated or embedded through the use of polymeric bonding agents, through embedding in a nickel or nickel alloy matrix, or through chemical vapor deposition.

Furthermore, at least a portion of at least one of the ribbon surfaces can also be coated with a flexible diamond-like carbon (DLC) coating or titanium nitride coating. Such coating can enhance the wear of the cutting edges.

There is tremendous flexibility in the manufacturing of the instruments of the present invention. If a straight edge does not provide a good cutting surface, a serrated edge can supplement the deficiency of the material. If the ribbon is not of sufficient flexibility at one thickness, a thinner ribbon can also be used.

Preferably, the ribbons are made of Ni/Ti alloys including those disclosed in U.S. Pat. Nos. 4,538,989, 5,464,362, 5,527,205, 5,628,674, 5,655,950, 5,762,497, 5,762,541, 5,833,457, 5,941,760, 6,293,795; and amorphous metals including those disclosed in U.S. Pat. No. 6,682,611 and U.S. Patent Application no. 2004/0121283, incorporated herein by reference.

Liquid metals can include amorphous metals and nanocrystalline materials. These generally have superior strength/hardness and elasticity. These metal alloys comprise binary alloys of zirconium and/or titanium, ternary alloys including Cu—Ti_Zr, Ln-Al-TM, Mg-Ln-TM, Zr—Al-TM, Hf—Al-TM, Ti—Zr-TM, or other complex alloys including Zr—Al—Co—N—Cu, Zr—Ti—Al—Ni—Cu, Zr—Ti—Nb—Al—Ni—Cu, Zr—Ti—Hf—Al—Co—Ni—Cu, and Zr—Be—Ti—Cu—Ni (Ln is a Lathanide metal and TM is a transition metal of groups VI to VIII).

Some instruments and devices prepared according to the prior art, and using prior art materials are subject to breakage. This breakage may have a variety of causes, including inadequate removal of dental chips which are cut from the wall of the root canal. For example, unremoved dental chips may interfere with a motion of a conventional instrument with respect to the tooth, and thereby result in excessive forces being applied to the conventional instrument. The instruments of the present invention, however, can facilitate the removal of dental chips and other interfering materials from the subject tooth. Accordingly, the opportunity for breakage of a dental instrument of the invention is reduced.

Without wishing to be bound by a theory, it is observed that an instrument of the present invention includes continuous helical cutting edges 12, and exhibits the ability to adapt the diameter of the instrument by simply twisting, rotating, or applying an extensional or contracting force. These abilities of the dental instrument of the invention contribute to more efficient cutting and removal of the diseased tissues and also allow the dental instrument to conform to, and bypass, an impediment such as a dental chip without breaking.

Further, the instrument includes a substantially hollow interior 11 (as shown, e.g., in FIG. 1). This feature can also aid in the removal of dead tissue and other debris from the canal after the debris has been cut away from the tooth. For example, the ribbon of the instrument of the present invention may be arranged to allow the debris to pass between the edges thereof, or through apertures therein, and thereby into the hollow interior of the instrument. As a result, the dental chips are less likely to be engaged between the instrument and the root canal wall. Consequently, friction between the dental instrument and the tooth is reduced. Therefore, the torque that can be applied to the instrument is reduced, as is the opportunity for breakage of the instrument. Thus, the construction of the instrument can also potentially decrease the amount of torsional stress exerted on it.

In addition, the continuous nature of the cutting configurations of the instruments of the present invention can also minimize stress points generally present in prior art instrument due to way those prior art instruments are manufactured, such as grinding or hacking of cutting edges into the solid materials.

In a further embodiment, the ribbon 15 can be wound telescopically around a post, rod or wire 50, as shown in FIG. B. The post comprises a large diameter end 51 and tapers to a smaller diameter end 52. The ribbon 15 can be attached to the post at the smaller diameter end of the post by any attachment means, such as welding, soldering, or with the aid of an adhesive. The winding around the post is such that the diameters along the length of the instrument remain changeable by rotating or twisting the post.

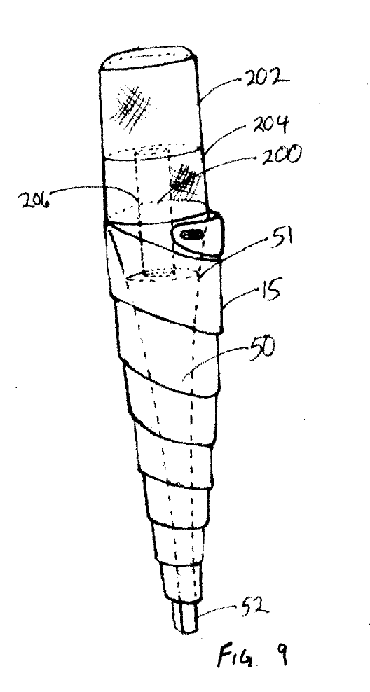

In still another embodiment, the twisting of the post may be effected by a rotatable coupling device adapted to change a position of one end of the ribbon 15 with respect to a position of the other end of the ribbon. An example of such an embodiment is shown in FIG. 9.

In FIG. 9, a post, rod or wire 50 is disposed within a coil of ribbon 15. The ribbon 15 is coupled to the post 50 at a small diameter end 52 of the post. The post includes a large diameter end 51. A neck, or shaft 200 is substantially fixedly coupled between the large diameter end 51 and a first knob or actuator 202. The FIG. 9 embodiment also includes a collar 204 having an axial channel, or bore, 206. The shaft 200 is rotatably disposed within the bore 206, and a proximal end of the ribbon 15 is coupled to the collar 200. Consequently, by rotation of the collar 204, manually or otherwise, with respect to the knob 202, the respective positions of the first and second ends of the ribbon 15 may be readily adjusted. It follows that the spatial configuration of the ribbon may be correspondingly modified by twisting of the knob 202 in relation to the collar 204.

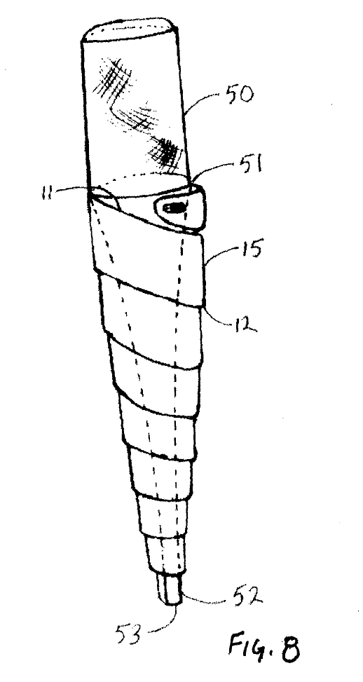

The post, rod or wire, 50 as shown, for example, in FIGS. 8 and 9 can include a metal, a polymer or mixtures thereof, with the preferred materials comprising the same materials as used for the construction of the ribbon 15. Also, the post does not have to endure the same amount of torsional stress as the shanks of traditional endodontic instruments. This gives more flexibility in the selection of materials than traditional instruments.

As noted above, once as much of the diseased tissue as practicable is removed from the root canal, the canal is sealed closed. The sealing action is normally done by reciprocating and/or rotating a condenser/compactor instrument in the canal to urge a sealing material such as gutta-percha into the canal. The gutta-percha used is generally viscous. Hence, any condenser/compactor instrument used also needs to withstand high torsional stress in order to urge the sealing compound into the vacated canal.

The sealing compound, once it is delivered into the vacated canal, must be packed and compacted without leaving any voids in the canal which may lead to complications later. This further adds to the demand for high resistance to stress. Generally, this filling action is done by coating the gutta-percha on the condenser/compactor, and the coated instrument is then inserted into the prepared canal and the rotating and reciprocating action compacts the gutta-percha.

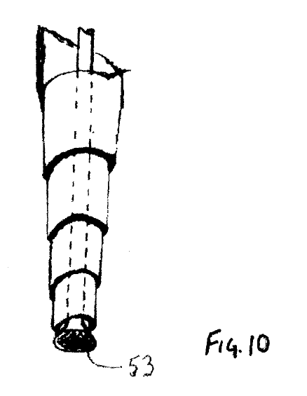

In addition to being a more efficient cutter, instruments of the present invention can also act as a condenser/compactor. Gutta-percha can be loaded onto the outside or into the substantially hollow interior 11 of the instrument. Without wishing to be bound to a theory, it is surmised here that by applying a rotation or reciprocating action, the diameter of the instrument is changed. As the diameter is changed, gutta-percha is extruded from the outside edges 12. In other words, the gutta-percha is squeezed out of the interior of the instrument between the edges 12 and/or through apertures provided for the purpose (as shown, for example, at 280 on FIG. 12), and deposited in the prepared canal. The tip can also serve to compact the gutta-percha. According to one embodiment of the invention, as illustrated in FIG. 10, a tip of the instrument can also include a compacting surface 53. The compacting surface 53 at the tip of the instrument can be used as a compactor to compact the gutta-percha.

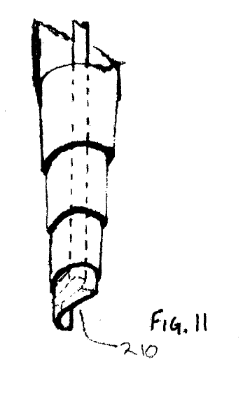

In another embodiment, as shown in FIG. 11, the instrument can alternatively be constructed with a small opening 210 at the small diameter end through which gutta-percha can pass into the canal.

Further, when traditional instruments are used in a root canal procedure, files of increasingly larger diameters are used in sequence to achieve the desired cleaning and shaping. On the other hand, the instrument of the present invention can adapt its diameter so that the dentist does not have to change the instrument during the various stages of the root canal process. This can increase the efficiency of the operation.

When the instruments of the present invention are used to clean out and shape the root canal, they can be rotated and reciprocated in the canal by the dentist, either manually or with the use of a dental handpiece which mounts the instrument.

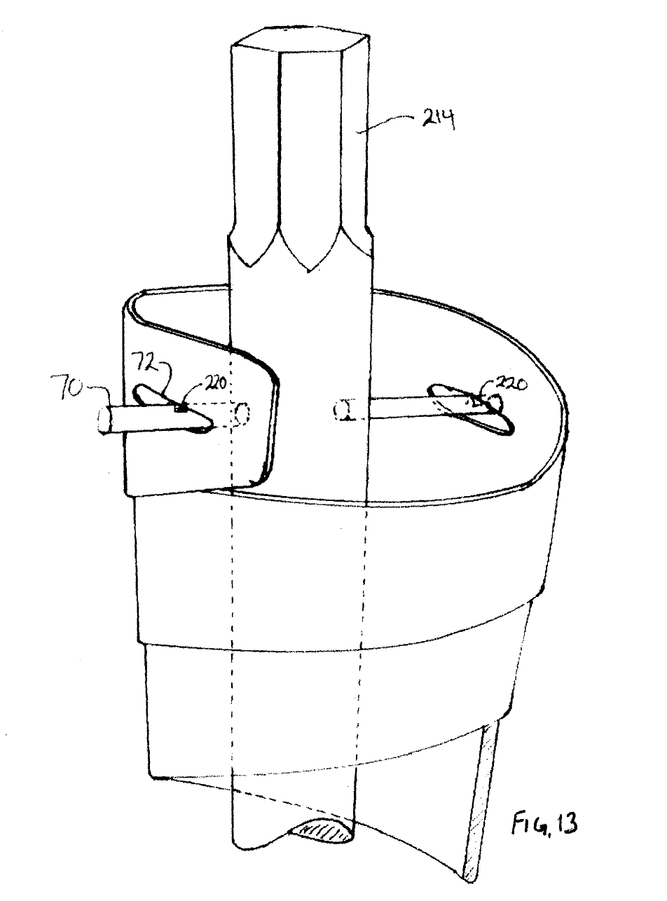

In some embodiments, the large diameter end of the instrument can be fitted with an attachment means for facilitating use with a rotary handpiece or for facilitating manual use by a dentist. The attachment means can include any means that can enable the instrument to be held, either by a dentist or a rotary handpiece so that it can be rotated with ease. As noted above, the diameters of the instrument can be changed when it is rotated or reciprocated. Exemplary embodiments are shown in FIGS. 12 and 13.

Accordingly, FIG. 12 shows a dental instrument according to one embodiment of the invention. As seen in FIG. 12, the dental instrument includes a substantially cylindrical shaft region 212. The shaft region 212 is adapted to be received into a collet or chuck of a rotary handpiece.

FIG. 13 shows an embodiment of the invention having a plurality of substantially flat regions adapted to be received into the collet or chuck. In various embodiments, one or more flat regions may be employed to improve torsional coupling between a collet or chuck and the dental instrument. Alternately, a machine key, a pin, or a shaft region having an elliptical or other non-circular cross section may be employed to improve torsional coupling of the dental instrument.

In FIGS. 12 and 13, for example, at least one horizontal bar 70 is attached to the uppermost turn of the ribbon at the large diameter end of the rod or post. This attachment can be effected by means of, for example, two slots 72, 74 in the ribbon 15. According to one preferred embodiment, the two slots 72, 74 are disposed substantially opposing one another for balancing in the ribbon, as shown in FIG. 12. Various modes of attachment of the bar to the shaft or post are contemplated, such as, e.g., welding or soldering, or by means of threads or threaded fasteners.

Also shown on the ribbon 15 of the FIG. 12 embodiment are exemplary apertures or cutouts 280. These apertures are adapted to allow the egress of gutta-percha from the hollow interior of the instrument. The apertures are also adapted to allow the ingress of dental chips and other debris into the hollow interior of the instrument for removal out of the tooth.

As shown in FIG. 13, the bar 70 can also include striations 220 in a surface thereof. The striations are adapted to receive respective edges of the slots present in the ribbon 15, and thereby to maintain alignment of the ribbon 15.

The bar 70 is preferably constructed of a material that can withstand torsional and bending stress, such as the stainless steel and Ni/Ti alloys used in the conventional endodontic files noted above.

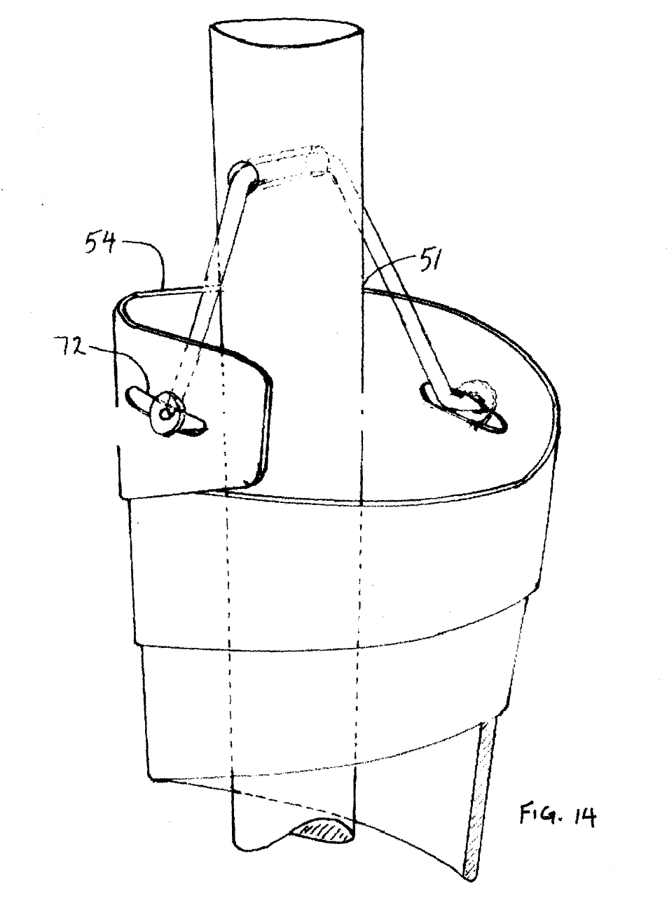

In FIG. 14, at least two substantially, vertically slanting bars (as shown), wires, chains or ropes (not shown) are attached to the ribbon at the uppermost turn at the large diameter end and serve to mechanically couple the ribbon to the post. The means of attaching these bars, chains or ropes are similar to those mentioned above for the exemplary horizontal bar. Also, the bars, wires, chains or ropes are preferably resistant to stress, and thus can be made of materials suitable for the horizontal bars mentioned above.

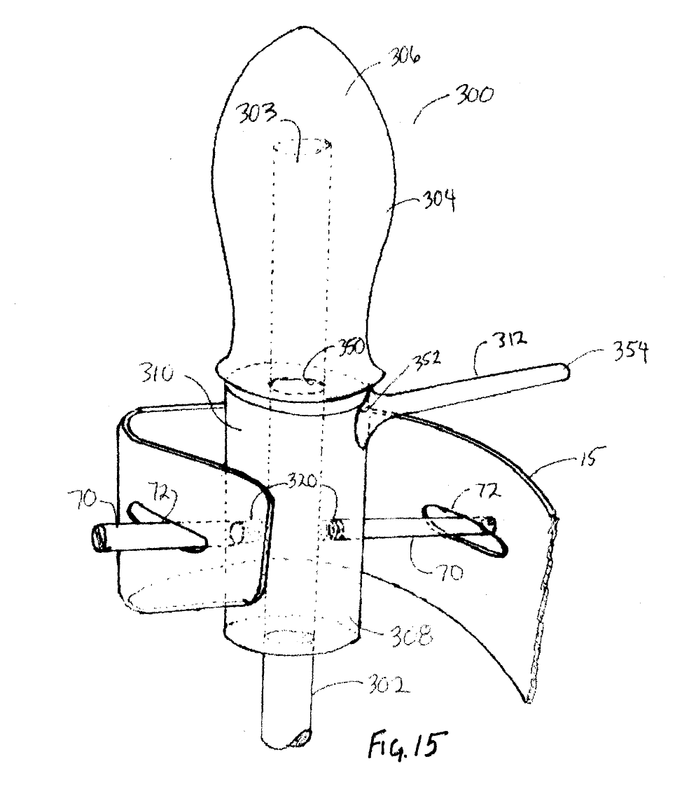

FIG. 15 shows, in various aspects, a further embodiment of a dental instrument 300 according to the invention. The instrument 300 includes a shaft 302 disposed coaxially within a helical ribbon 15. A proximal end 303 of the shaft 302 is substantially fixedly coupled to a handle 304. The handle 304 includes an outer surface 306 that is shaped to facilitate manipulation of the handle by a user.

A collar 308 is disposed such that the shaft 302 is rotatably supported within a bore 350 of the collar 308 and disposed along a longitudinal axis of the collar 308. The collar 308 includes an outer surface 310 that, according to the illustrated embodiment, is substantially cylindrical. A lever 312 includes a first end 352 coupled to the collar 308 at surface 310 and a second end 354 disposed outwardly of the surface 310 for ready manipulation by the user.

The collar is also coupled to the ribbon 15 by bars 70 and slots 72 in a manner analogous to that shown in, and described in relation to, FIG. 13. In the illustrated embodiment, the bars 70 are threadedly coupled within respective internally threaded holes 320 of the collar 310.

In operation, a user such as a dental professional grasps the handle 304 and rotates the lever 312 about the shaft 302 with a finger or thumb. This serves to adjust the arrangement of the ribbon 15, contracting, expanding, retracting or extending it in the manner described above in relation to FIG. 8.

As noted before, the ribbons can be made in any known process. At the same time, the instruments can also be made with any process suitable for making coiled structures. An exemplary method may include rolling a strand of ribbon 15 into a helix or twister of a diameter typical of the any traditional files used in a root canal procedure. The twister is then heat set according to any known methods used in any typical heat setting process. The heat set treatment gives the file shape memory so that it will return to this original shape after the removal of any stress.

Of course, any process that is amenable to mass production of instruments of the present invention is anticipated. The instruments can also be made in a variety of diameters, as desired.

Having described the invention with reference to exemplary and/or preferred embodiments, it is further depicted in the appended claims below.

1-52. (canceled)

53. An endodontic instrument comprising turns of a ribbon, said turns of said ribbon wound telescopingly along the longitudinal axis of the post includes an inner surface defining a hollow region therewithin, wherein said hollow region is adapted for delivering an endodontic repair material.

54. The endodontic instrument of claim 53 wherein said endodontic repair material comprises gutta-percha.

55. The endodontic instrument of claim 53 wherein said endodontic repair material is loaded into the hollow region, and is delivered to a prepared canal with the aid of said rotating handpiece.

56. A method of using endodontic instrument comprising turns of a ribbon for delivering an endodontic repair material, said turns of said ribbon wound telescopingly along the longitudinal axis of the post includes an inner surface defining a hollow region therewithin, and said repair material is delivered by turning the telescopically wound ribbon.
